(19) United States
(12) Patent Application Publication
(10) Pub. No.: US 2011/0203866 A1
(43) Pub. Date: Aug. 25, 2011

(54) SEATBELT SAFETY APPARATUS AND METHOD FOR CONTROLLING IGNITION OF AUTOMOTIVE VEHICLES

(75) Inventors: Jesus Hinojosa, JR., Dallas, TX (US); Amado Crisolfo Coronado, Dallas, TX (US)

(73) Assignee: Mesa Digital, LLC.

(21) Appl. No.: 13/017,196

(22) Filed: Jan. 31, 2011

Related U.S. Application Data
(60) Provisional application No. 61/307,530, filed on Feb. 24, 2010.

(51) Int. Cl. B60R 22/48; B60K 28/02

(52) U.S. Cl. 180/270

(57) ABSTRACT

A seatbelt safety apparatus and method for controlling ignition with respect to an automotive vehicle. The apparatus generally includes a seatbelt associated with a seatbelt sensor and an ignition interlock clip circuit. The seatbelt sensor that senses heat can be located on a front portion of the seatbelt to ensure that the seatbelt is strapped in an operative position with respect to an occupant in the vehicle and is worn properly. The ignition interlock clip circuit associated with a seatbelt clip controls the ignition with respect to the vehicle. An electrical connection can be made when a fastening member associated with the seatbelt is connected with the clip circuit in order to ignite the vehicle. The ignition will not start unless the seatbelt is fastened with the seatbelt clips by the occupant in the automobile.

CROSS-REFERENCE TO PROVISIONAL APPLICATION

This nonprovisional patent application claims the benefit under 35 U.S.C. §119(e) of U.S. Provisional Pat. App. Ser. No. 61/307,530 filed on Feb. 24, 2010, entitled “Seatbelt Safety Apparatus and Method for Controlling Ignition of Automotive Vehicles,” which is hereby incorporated by reference in its entirety.

TECHNICAL FIELD

Embodiments are generally related to automotive vehicle safety restraint systems and methods. Embodiments are also related to seatbelt apparatus. Embodiments are additionally related to techniques for controlling ignition of automotive vehicles.

### BACKGROUND OF THE INVENTION

Safety seatbelt systems can be employed to secure an occupant in a seat associated with a vehicle and to provide a safe driving environment. Such seatbelts prevent the wearer from hitting hard interior elements associated with the vehicle in which they are riding and being thrown from the vehicle in the event of an accident. More often many occupants may forget or refuse to fasten the seatbelts while driving. Such negligence may lead to serious injuries to the occupant in case of a sudden movement or the accident of the automobile.

Conventional seatbelt apparatus generally includes a seatbelt warning system in order to prompt the occupant to utilize the seatbelts. Such systems generally provide a visual and/or audible warning signal typically from the moment the car ignition is activated until the seatbelts are fastened. Additionally, such prior art systems monitor merely the coincidence between an occupied seat and the buckling of the associated seatbelt, however, the occupant can merely buckle the belt behind him to fool the system. Furthermore, such prior art seatbelt apparatus are expensive, difficult to service, and unsuitable for retrofitting to a vehicle.

Based on the foregoing, it is believed that a need exists for an improved seatbelt safety apparatus and method. A need also exists for an improved ignition interlock circuit for controlling ignition with respect to an automotive vehicle, as described in greater detail herein.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved seatbelt safety apparatus and method for an automotive vehicle.

It is another aspect of the disclosed embodiments to provide for an improved ignition interlock circuit for controlling ignition with respect to the automotive vehicle.

It is a further aspect of the disclosed embodiments to provide for an improved seatbelt sensor in order to sense an operative position of the seatbelt.

The aforementioned aspects and other objectives and advantages can now be achieved as described herein. A seatbelt safety apparatus and method for controlling ignition with respect to an automotive vehicle is disclosed herein. The apparatus generally includes a seatbelt associated with a seatbelt sensor and an ignition interlock clip circuit. The seatbelt sensor that senses heat (e.g., body heat) can be located on a front portion of the seatbelt to ensure that the seatbelt is strapped across an occupant's body and is worn properly. The ignition interlock clip circuit associated with a seatbelt clip controls the ignition with respect to the vehicle. An electrical connection can be made when a fastening member associated with the seatbelt is connected with the clip circuit in order to ignite the vehicle. The ignition will not start unless the seatbelt is fastened with the seatbelt clips by the occupant in the automobile.

The clip circuit associated with the seatbelt clip can be connected to an electrical circuit that includes an ignition switch and a power source. The ignition switch can further be connected to an engine starter motor to assist in activating the automotive vehicle. The clip circuit can make an electrical connection with the engine of the vehicle in order to ignite the vehicle when the fastening member is engaged with the seatbelt clip.

Similarly, when the fastening member is removed from the seatbelt buckle, the ignition switch can break the electrical connection with the engine and therefore stops the operation of the vehicle. The occupant can be also prompted to connect the fastening member with the clip circuit if the seatbelt is not buckled in order to start the vehicle. The seatbelt sensor and ignition interlock clip circuit is capable of promoting the seatbelt usage for operating the automobile in order to avoid serious injuries that may cause during sudden movements or accidents of the automobile.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a perspective view of a seatbelt safety apparatus associated with an automotive vehicle, in accordance with the disclosed embodiments;

FIG. 2 illustrates a schematic view of an ignition interlock clip circuit associated with a seatbelt clip, in accordance with the disclosed embodiments;

FIG. 3 illustrates a high-level flow chart of operations illustrating logical operational steps of a method for controlling ignition with respect to an automotive vehicle, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

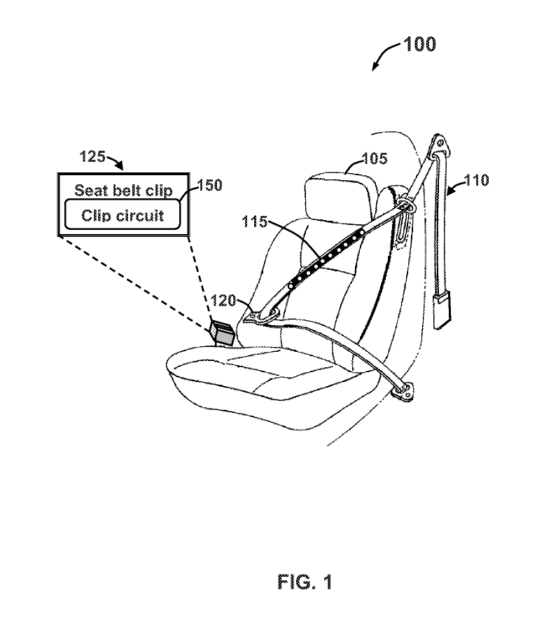

FIG. 1 illustrates a perspective view of a seatbelt safety apparatus 100 associated with a seat 105 of an automotive vehicle, in accordance with the disclosed embodiments. Note that in FIGS. 1-3, identical or similar blocks are generally indicated by identical reference numerals. The seatbelt apparatus 100 can be employed to protect an occupant of the vehicle in the event of an accident. The seatbelt safety apparatus 100 can be configured to include a seatbelt 110, an ignition interlock clip circuit 150 in association with a seatbelt clip 125 and a seatbelt sensor 115 incorporated in a front portion of the seatbelt 110.

A fastening member 120 associated with the seatbelt 110 can be engaged in association with the seatbelt clip 125 for fastening the seatbelt 110. The clip circuit 150 in the seatbelt clip 125 can then create an electrical connection in order to permit ignition of the vehicle. The fastening member 120 can be engaged in association with the seatbelt clip via screws, snaps, buckles, adhesives, reversible adhesives, hook and loop type fasteners, and other non-reversible and reversible fastening means as are known in the art. The clip circuit 150 herein can be a general interconnection of electrical elements such as, for example, resistors, inductors, capacitors, transmission lines, voltage sources, current sources, and switches, depending upon design considerations.

The seatbelt sensor 115 incorporated in the front portion of the seatbelt 110 detects the body heat of an occupant. When the occupant straps the seatbelt 110, the sensor 115 ensures that the seatbelt 110 is strapped across a person's body and not behind the person. The seatbelt safety apparatus 100 herein can thus ensure that the seatbelt 110 is clipped and fastened in the intended manner. The sensor 115 described herein may be, for example, a body temperature sensor, depending upon design considerations. It can be appreciated that other types of sensor can be utilized in place of the suggested material.

As required, detailed embodiments of the present invention are disclosed herein; however, it is to be understood that the disclosed embodiments are merely exemplary of the invention that may be embodied in various and alternative forms. It should be emphasized, however, that the present invention is not limited to a particular seatbelt controlled ignition circuit, as shown and described. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

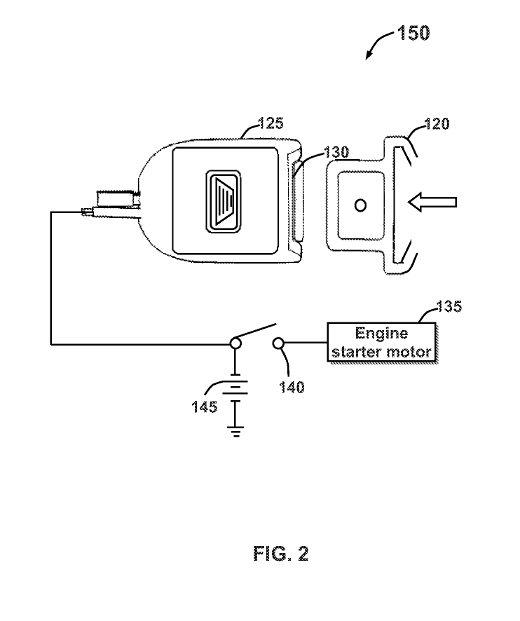

FIG. 2 illustrates a schematic view of the ignition interlock clip circuit 150 associated with the seatbelt clip 125, in accordance with the disclosed embodiments. The seatbelt clip assembly includes the seatbelt clip 125 and the fastening member 120 associated with the seatbelt 110. The seatbelt clip 125 includes a receiving portion 130 to receive the fastening member 120. The seatbelt clip 125 can be connected to an electrical circuit that includes an ignition switch 140 and a power source 145. The ignition switch 140 can be connected to an engine starter motor 135 to help operating the automotive vehicle.

The clip circuit 150 can make an electrical connection with the engine 135 of the vehicle in order to ignite the vehicle when the fastening member 120 is engaged with the seatbelt clip 125. The ignition switch 140 is closed and the power can be supplied from the power source 145 to the engine starter motor 135 in order to start the vehicle. Similarly, when the fastening member 120 is removed from the seatbelt belt clip 125, the ignition switch 140 can break the electrical connection with the engine 135 and therefore stops the operation of the vehicle.

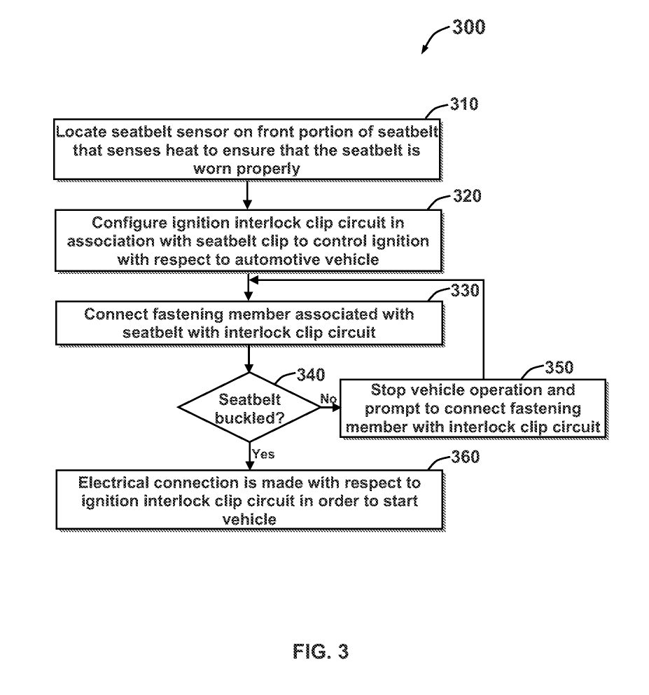

FIG. 3 illustrates a high-level flow chart of operations illustrating a method 300 for operation of the seatbelt safety apparatus, in accordance with the disclosed embodiments. The seatbelt sensor 115 that senses heat (e.g., body heat) can be located on the front portion of the seatbelt 110 to ensure that the seatbelt 110 is strapped across a person's body and is worn properly, as indicated at block 310. The seatbelt 100 can be further configured to include the ignition interlock clip circuit 150 in association with the seatbelt clip 125 operative to control the ignition with respect to the vehicle, as depicted at block 320. The fastening member 120 associated with the seatbelt 110 can be connected with the clip circuit 150, as illustrated at block 330.

A determination can be made whether the fastening member 120 is buckled with the seatbelt clip 125, as indicated at block 340. If the fastening member 120 is buckled with the seatbelt clip 125 an electrical connection can be made in order to start the vehicle, as illustrated at block 350. Otherwise, the vehicle operation is stopped and the occupant can be prompted to connect the fastening member 120 with the clip circuit 150, as depicted at block 360. The seatbelt sensor 115 and the ignition interlock clip circuit 150 are capable of promoting the seatbelt usage for operating the automobile in order to avoid serious injuries that may cause during sudden movements or accidents of the automobile.

Based on the foregoing, it can be appreciated that a seatbelt apparatus is disclosed, which includes in some embodiments, a seatbelt sensor located on a front portion of a seatbelt in order to ensure that the seatbelt is strapped in an operative position with respect to an occupant in a vehicle and is worn properly by the occupant. Such an apparatus can further include an ignition interlock clip circuit associated with a seatbelt clip and a fastening member associated with the seatbelt capable that detachably attaches with each other and provides an electrical connection if the fastening member is connected with the clip circuit in order to permit ignition of the vehicle or deny the ignition of the vehicle if the electrical connection is not made.

In other embodiments of such an apparatus, the ignition interlock clip circuit can also include an ignition switch connected to an engine starter motor associated with the vehicle. The apparatus can also include a power source associated with the ignition switch that makes the electrical connection with the engine starter motor in order to start the vehicle when the fastening member is engaged with the seatbelt clip. In still other embodiments of such an apparatus, the sensor can be a body temperature sensor.

In yet other embodiments, such an apparatus can include a seatbelt sensor located on a front portion of a seatbelt in order to ensure that the seatbelt is strapped in an operative position with respect to an occupant in a vehicle and is worn properly by the occupant, and an ignition interlock clip circuit associated with a seatbelt clip and a fastening member associated with the seatbelt capable of attaching with each other and provides an electrical connection if the fastening member is connected with the clip circuit in order to ignite the vehicle, wherein the sensor comprises a body temperature sensor. In such an embodiment, the ignition interlock clip circuit can include an ignition switch connected to an engine starter motor associated with the vehicle, and a power source associated with the ignition switch that makes the electrical connection with the engine starter motor in order to start the vehicle when the fastening member is engaged with the seatbelt clip.

In other embodiments, a method can also be provided for configuring the disclosed seatbelt apparatus. Such a method can include, for example, a step of locating a seatbelt sensor at a front portion of a seatbelt in order to ensure that the seatbelt is strapped in an operative position with respect to an occupant in a vehicle and is worn properly by the occupant. Such a method can also include, for example, a step of associating an ignition interlock clip circuit with a seatbelt clip. Additionally, such a method can include a step of associating a fastening member with the seatbelt so that the such components detachably attach to and from each other and assist in providing an electrical connection via the interlock clip circuit, if the fastening member is connected with the clip circuit in order to permit an ignition of the vehicle or deny the ignition of the vehicle if the electrical connection is not made.

In an alternative embodiment of such a method, the ignition interlock clip circuit can be configured to include, for example, an ignition switch connected to an engine starter motor associated with the vehicle; and a power source associated with the ignition switch that makes the electrical connection with the engine starter motor in order to start the vehicle when the fastening member is engaged with the seatbelt clip. In yet another embodiment of such a method, the sensor can be configured to be a body temperature sensor. Additionally, the ignition interlock clip circuit can include in some embodiments, an ignition switch connected to an engine starter motor associated with the vehicle. The ignition interlock clip circuit can also include a power source associated with the ignition switch that makes the electrical connection with the engine starter motor in order to start the vehicle when the fastening member is engaged with the seatbelt clip.

In still another embodiment of such a method, the ignition interlock clip circuit described herein can be configured to include an ignition switch connected to an engine starter motor associated with the vehicle, and a power source associated with the ignition switch that makes the electrical connection with the engine starter motor in order to start the vehicle when the fastening member is engaged with the seatbelt clip. The ignition interlock clip circuit can further include an ignition switch connected to an engine starter motor electrically and mechanically integrated with the vehicle.

In yet another embodiment of such a method, the ignition interlock clip circuit can be configured to include an ignition switch connected to an engine starter motor associated with the vehicle, and a power source associated with the ignition switch that makes the electrical connection with the engine starter motor in order to start the vehicle when the fastening member is engaged with the seatbelt clip. In such a method, the ignition interlock clip circuit can further include a power source associated with the ignition switch that completes the electrical connection with the engine starter motor in order to start the vehicle when the fastening member is engaged with the seatbelt clip.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A seatbelt apparatus, comprising:
a seatbelt sensor located on a front portion of a seatbelt in order to ensure that said seatbelt is strapped in an operative position with respect to an occupant in a vehicle and is worn properly by said occupant; and
an ignition interlock clip circuit associated with a seatbelt clip and a fastening member associated with said seatbelt, wherein said seatbelt clip and said fastening member detachably attach with each other and provide an electrical connection via said ignition interlock clip circuit, if said fastening member is connected with said clip circuit in order to permit an ignition of said vehicle or deny said ignition of said vehicle if said electrical connection is not made.

2. The apparatus of claim 1 wherein said ignition interlock clip circuit further comprises:
an ignition switch connected to an engine starter motor associated with said vehicle; and
a power source associated with said ignition switch that makes said electrical connection with said engine starter motor in order to start said vehicle when said fastening member is engaged with said seatbelt clip.

3. The apparatus of claim 1 wherein said sensor comprises a body temperature sensor.

4. The apparatus of claim 1 wherein said ignition interlock clip circuit further comprises an ignition switch connected to an engine starter motor associated with said vehicle.

5. The apparatus of claim 4 wherein said ignition interlock clip circuit further comprises a power source associated with said ignition switch that makes said electrical connection with said engine starter motor in order to start said vehicle when said fastening member is engaged with said seatbelt clip.

6. The apparatus of claim 1 wherein said ignition interlock clip circuit further comprises:
an ignition switch connected to an engine starter motor associated with said vehicle; and
a power source associated with said ignition switch that makes said electrical connection with said engine starter motor in order to start said vehicle when said fastening member is engaged with said seatbelt clip; and
wherein said sensor comprises a body temperature sensor.

7. A seatbelt apparatus, comprising:
a seatbelt sensor located on a front portion of a seatbelt in order to ensure that said seatbelt is strapped in an operative position with respect to an occupant in a vehicle and is worn properly by said occupant; and
an ignition interlock clip circuit associated with a seatbelt clip and a fastening member associated with said seatbelt, wherein said fastening member and said seatbelt clip are capable of detachably attaching with each other and provide an electrical connection via said ignition interlock clip circuit, if said fastening member is connected with said clip circuit, in order to ignite said vehicle, wherein said sensor comprises a body temperature sensor.

8. The apparatus of claim 7 wherein said ignition interlock clip circuit further comprises:
an ignition switch connected to an engine starter motor associated with said vehicle; and
a power source associated with said ignition switch that makes said electrical connection with said engine starter motor in order to start said vehicle when said fastening member is engaged with said seatbelt clip.

9. The apparatus of claim 7 wherein said ignition interlock clip circuit further comprises an ignition switch connected to an engine starter motor electrically and mechanically integrated with said vehicle.

10. The apparatus of claim 7 wherein said ignition interlock clip circuit further comprises a power source associated with said ignition switch that completes said electrical connection with said engine starter motor in order to start said vehicle when said fastening member is engaged with said seatbelt clip.

11. A method of configuring a seatbelt apparatus, said method comprising:
locating a seatbelt sensor at a front portion of a seatbelt in order to ensure that said seatbelt is strapped in an operative position with respect to an occupant in a vehicle and is worn properly by said occupant; and
associating an ignition interlock clip circuit with a seatbelt clip;
associating a fastening member with said seatbelt to assist in providing an electrical connection if said fastening member is connected with said clip circuit and permit an ignition of said vehicle or deny said ignition of said vehicle if said electrical connection is not made.

12. The method of claim 11 further comprising configuring said ignition interlock clip circuit to comprise at least:
an ignition switch connected to an engine starter motor associated with said vehicle; and
a power source associated with said ignition switch that makes said electrical connection with said engine starter motor in order to start said vehicle when said fastening member is engaged with said seatbelt clip.

13. The method of claim 11 further comprising configuring said sensor to comprise a body temperature sensor.

14. The method of claim 11 wherein said ignition interlock clip circuit further comprises an ignition switch connected to an engine starter motor associated with said vehicle.

15. The method of claim 14 wherein said ignition interlock clip circuit further comprises a power source associated with said ignition switch that makes said electrical connection with said engine starter motor in order to start said vehicle when said fastening member is engaged with said seatbelt clip.

16. The method of claim 15 further comprising configuring said sensor to comprise a body temperature sensor.

17. The method of claim 11 further comprising configuring said ignition interlock clip circuit to include:
an ignition switch connected to an engine starter motor associated with said vehicle; and
a power source associated with said ignition switch that makes said electrical connection with said engine starter motor in order to start said vehicle when said fastening member is engaged with said seatbelt clip, wherein said ignition interlock clip circuit further comprises an ignition switch connected to an engine starter motor electrically and mechanically integrated with said vehicle.

18. The method of claim 17 further comprising configuring said sensor to comprise a body temperature sensor.

19. The method of claim 11 further comprising configuring said ignition interlock clip circuit to include:
an ignition switch connected to an engine starter motor associated with said vehicle; and
a power source associated with said ignition switch that makes said electrical connection with said engine starter motor in order to start said vehicle when said fastening member is engaged with said seatbelt clip, wherein said ignition interlock clip circuit further comprises a power source associated with said ignition switch that completes said electrical connection with said engine starter motor in order to start said vehicle when said fastening member is engaged with said seatbelt clip.

20. The method of claim 19 further comprising configuring said sensor to comprise a body temperature sensor.
